(19) United States
(12) Patent Application Publication
(10) Pub. No.: US 2011/0065430 A1
(43) Pub. Date: Mar. 17, 2011

(54) METHOD AND APPARATUS FOR PAGING DELEGATION IN HETEROGENEOUS NETWORKS

(75) Inventors: Junghoon JEE, Daejeon (KR); Chang Min Park, Daejeon (KR)

(73) Assignee: Electronic and Telecommunications Research Institute, Daejeon (KR)

(21) Appl. No.: 12/881,527

(22) Filed: Sep. 14, 2010

(30) Foreign Application Priority Data
Sep. 14, 2009 (KR) 10-2009-0086518
Aug. 23, 2010 (KR) 10-2010-0081570

(51) Int. Cl. H04W 4/00

(52) U.S. Cl. 455/426.1

(57) ABSTRACT

A method for paging delegation in a gateway of a first network among heterogeneous networks is provided. The gateway of the first network receives a first request message that requests paging delegation of the first network from the terminal, and transmits a second request message that requests paging delegation of the first network to a paging controller of the second network. The gateway receives a first response message including a result value for the paging delegation request from the paging controller, sets paging delegation registration information of the terminal based on the first response message, and transmits a second response message.

### CROSS-REFERENCE TO RELATED APPLICATION

This application claims priority to and the benefit of Korean Patent Application Nos. 10-2009-0086518 filed in the Korean Intellectual Property Office on Sep. 14, 2009 and 10-2010-0081570 filed in the Korean Intellectual Property Office on Aug. 23, 2010, the entire contents of which are incorporated herein by reference.

### BACKGROUND OF THE INVENTION

(a) Field of the Invention

The present invention generally relates to a method and apparatus for paging delegation in heterogeneous networks.

(b) Description of the Related Art

For performing communication with heterogeneous networks, a terminal may be equipped with a plurality of wireless access interfaces. A paging process is required for determining present location of the terminal having a plurality of wireless access interfaces, i.e., multimode interface. However, when the coverage of a specific wireless network is narrow or paging cannot be supported in a specific wireless access interface, it may be difficult to determine the present location of the terminal when processing traffic toward a specific wireless access interface in the network.

### SUMMARY OF THE INVENTION

Embodiments of the present invention provide a method and apparatus for paging delegation in heterogeneous networks for easily determining a location of a terminal in the heterogeneous networks.

According to an embodiment of the present invention, a method for paging delegation in a gateway of a first network among heterogeneous networks is provided. The method for paging delegation includes receiving from a terminal a first request message that requests a second network to perform paging delegation of the first network, transmitting to a paging controller of the second network a second request message that requests paging delegation of the first network, receiving a first response message including a result value for the paging delegation request from the paging controller, setting paging delegation registration information of the terminal based on the first response message, and transmitting a second response message to the terminal.

When a result value of the first response message represents success of the paging delegation request, the paging delegation information may include information on the paging controller and a status value of an interface for the first network of the terminal. Here, the status value may represent that the interlace for the first network is reachable via the second network. Further, the information of the paging controller may include at least one of an identifier of the paging controller, an internet protocol (IP) address, and a medium access control (MAC) address. A paging delegation method according to another embodiment of the present invention includes receiving traffic toward a terminal, confirming information that the status of an interface for the first network of the terminal is reachable via a second network and information on a paging controller of the second network based on paging delegation registration information of the terminal, transmitting a paging request message to the paging controller, and receiving a response message to the paging request message from the paging controller.

When a result value of the response message represents success of the paging request, the paging controller may perform paging to the terminal.

According to yet another embodiment of the present invention, an apparatus for paging delegation including a transceiver, a database, and a paging delegation register is provided.

The transceiver receives from a terminal a first request message that requests paging delegation of a first network, transmits a second request message that requests paging delegation to a paging controller of a second network, receives a first response message including a result value for a paging delegation request from the paging controller, and transmits a second response message to the terminal.

The paging delegation register sets paging delegation registration information of the terminal on the database. The transceiver may transmit a paging request message to the paging controller based on the paging delegation registration information when traffic toward the terminal occurs, and receive a third response message corresponding to the paging request message from the paging controller.

### BRIEF DESCRIPTION OF THE DRAWINGS

FIG. 1 is a schematic diagram showing a heterogeneous network according to an embodiment of the present invention.

FIG. 2 shows a method for paging delegation registration according to an embodiment of the present invention.

FIG. 3 shows a method for paging delegation according to an embodiment of the present invention.

FIG. 4 is a schematic block diagram showing an anchor DPF (data path function) unit according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the following description, the term “terminal” may designate a mobile station (MS), a mobile terminal (MT), a subscriber station (SS), a portable subscriber station (PSS), user equipment (UE), an access terminal (AT) and so on, and may include all or some functions thereof.

Further, the term “base station” (BS) may designate an access point (AP), a radio access station (RAS), a nodeB, an evolved nodeB (eNodeB), a base transceiver station (BTS), an MMR (mobile multihop relay)-BS and so on, and may include all or some functions thereof.

Hereinafter, a method and apparatus for paging delegation in heterogeneous networks according to an embodiment of the present invention will be described with reference to the accompanying drawings.

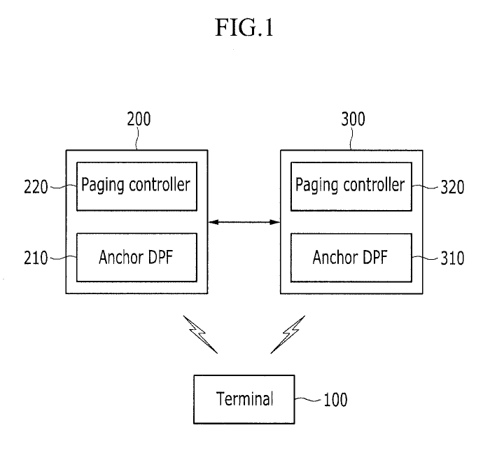

FIG. 1 is a schematic diagram showing heterogeneous networks according to an embodiment of the present invention.

Referring to FIG. 1, the heterogeneous networks include a terminal 100 and a plurality of gateways 200 and 300 that are located in different networks, respectively.

The terminal 100 includes a wireless access interface that can access the different networks, i.e., a multimode interface. Here, the multimode interface may be implemented in the form of a combination of various wireless access interfaces for heterogeneous networks, and may be defined to include various wireless access interfaces mounted in the terminal 100.

The multimode interface may include various types of wireless access interfaces, for example, a WiMAX network interface, a WiFi network interface, a 3GPP network interface, and the like.

Each gateway 200/300 includes at least one of an anchor data path function unit (hereinafter referred to as “anchor DPF”) 210/310 and a paging controller 220/320. When a wireless access interface of a terminal 100 corresponding to the network to which the anchor DPF 210 belongs is power-off or deregistered, the anchor DPF 210 receives data toward the terminal 100. The paging controller 220 performs a paging process to determine the location of the terminal 100.

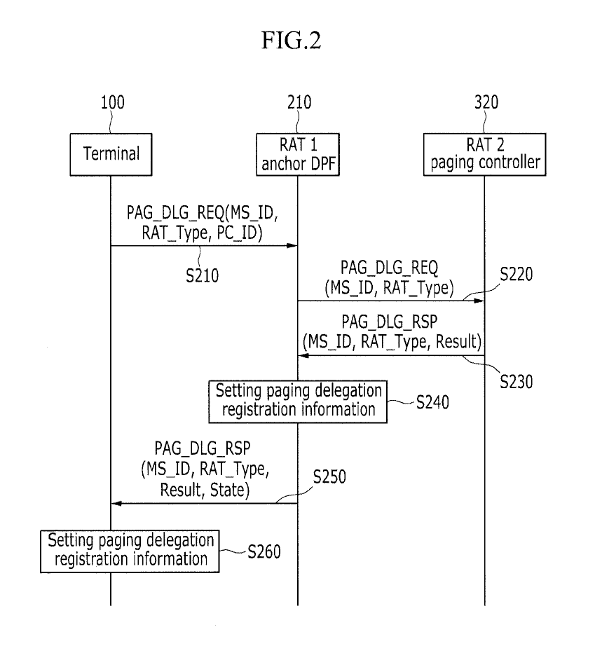

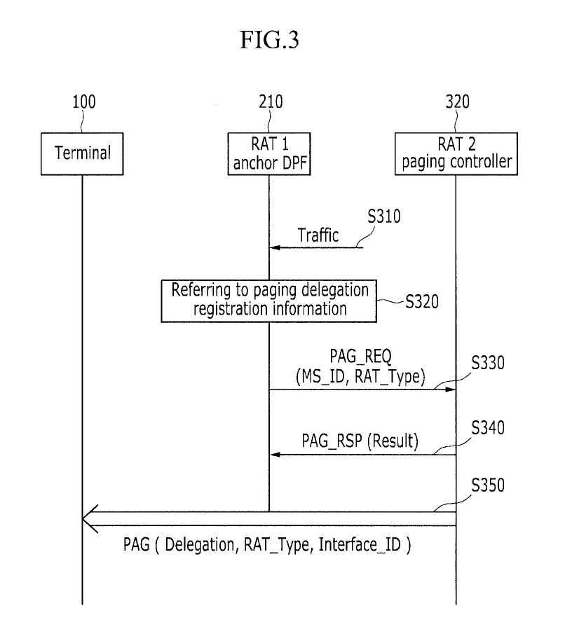

FIG. 2 shows a method for paging delegation registration according to an embodiment of the present invention, and FIG. 3 shows a method for paging delegation according to an embodiment of the present invention.

In FIG. 2 and FIG. 3, it is assumed that a network using one radio access technology (hereinafter referred to as “RAT1 network”) is the network which requests paging delegation because of powering off of a corresponding interface, deregistration, narrow coverage of the RAT1 network, and so on, and a networkusing the other different wireless access technology (hereinafter referred to as “RAT2 network”) is the network which performs the paging delegation.

Referring to FIG. 2, the terminal 100 transmits a paging delegation request message PAG_DLG_REQ to the anchor DPF 210 of the RAT1 network (S210). The terminal 100 may directly request the RAT2 network to delegate a paging process of the RAT1 network through a paging delegation request message PAG_DLG_REQ. The paging delegation request message PAG_DLG_REQ includes type information RAT_Type of a network that has requested paging delegation, an identifier MS_ID of the terminal 100, and an identifier PC_ID of the paging controller 320 of the network (e.g., RAT2 network) for performing the paging delegation. The type information RAT_Type is the type of radio access technology of the current serving access network, and is represented as RAT1 in an example shown in FIG. 2.

The anchor DPF 210 transmits a paging delegation request message PAG_DLG_REQ (S220) to the paging controller 320 of the RAT2 network, based on the identifier PC_ID of the paging controller 320 which is included in the paging delegation request message PAG_DLG_REQ (S210). In this case, the paging delegation request message PAG_DLG_REQ includes the identifier MS_ID of the terminal 100 and the type information RAT_Type of the RAT1 network.

The paging controller 320 transmits a response message PAG_DLG_RSP to the paging delegation request message PAG_DLG_REQ to the anchor DPF 210 (S230). The response message PAG_DLG_RSP includes the identifier MS_ID of the terminal, the type information RAT_Type of the RAT1 network, and a result value of the paging delegation request. For example, when the paging delegation request succeeds, the result value may be configured as “0”, and when the paging delegation request fails, the result value may be configured as “1”.

When the result value of the received response message PAG_DLG_RSP represents success (for example, “0”), the anchor DPF 210 sets paging delegation registration information for the RAT1 network of the terminal 100 (S240).

The paging delegation registration information may be set, for example, as Table 1.

TABLE 1

| Status of paging | | Paging |
|---|---|---|
| delegation | | controller |
| registration | Interface status | information |
| Paging_Delegation: | REACHABLE_VIA_ANOTHER: | PC_ID, |
| On, Off | Anchor_RAT_Type | IP address, |
| | REACHABLE_DIRECTLY | MAC address |
| | NON_REACHABLE | |

In Table 1, when the result value of the response message PAG_DLG_RSP is success (“0”), “Paging_Delegation” in the status of paging delegation registration is set as “On”, and when the result value of the response message PAG_DLG_RSP is failure (“1”), “Paging_Delegation” in the status of paging delegation registration is set as “Off”. In the example of FIG. 2, “REACHABLE_VIA_ANOTHER” in the interface status is set by Anchor_RAT_Type, i.e., RAT2, which indicates that RAT1 interface status of the terminal 100 is reachable via the RAT2 network. The paging controller information is the information on the paging controller 320 of the RAT2 network, i.e., at least one of the identifier PC_ID of paging controller, an internet protocol (IP) address, and a medium access control (MAC) address.

Thereafter, the anchor DPF 210 notifies the terminal 100 of the result of the paging delegation request by transmitting the response message PAG_DLG_RSP (S250). In this case, the response message PAG_DLG_RSP includes the identifier MS_ID of the terminal 100, the type information RAT_Type of the RAT1 network, the result value, and a status value. The status value represents a status value of the RAT1 interface of the terminal 100. In the example of FIG. 2, it is set as “REACHABLE_VIA_ANOTHER: RAT2”. The terminal 100 sets the paging delegation registration information based on the response message PAG_DLG_RSP (S260).

As described above, since the terminal 100 set the RAT2 network as the paging delegation network of the RAT1 network, the paging can be performed in the RAT2 network when the RAT1 network cannot perform paging. Hereinafter, a method for paging delegation will be described referring to FIG. 3.

Referring to FIG. 3, when a traffic toward the anchor DPF 210 of the RAT1 network occurs (S310), the anchor DPF 210 refers to the paging delegation registration information (S320).

Referring to the example in FIG. 2, the anchor DPF 210 confirms that the status of RAT1 interface of the terminal 100 is reachable via the RAT2 network, and the information about the paging controller 320 of the RAT2 network, i.e., at least one of the identifier PC_ID, the IP address, and the MAC address, by referring to the paging delegation registration information.

The anchor DPF 210 transmits a paging request message PAG_REQ to the paging controller 320 of the RAT2 network, based on the information that is confirmed by referring to the paging delegation registration information (S330). The paging request message PAG_REQ includes a terminal identifier MS_ID and type information RAT_Type of the RAT1 network that requests paging delegation.

The paging controller transmits a response message REG_RSP to the paging request message PAG_REQ to the anchor DPF 210 (S340). The response message PAG_RSP includes the result value for the paging request. For example, the result value may be set as “0” when the paging request succeeds, and the result value may be set as “1” when the paging request fails.

When the paging controller accepts the paging request, that is, transmits the response message PAG_RSP representing success to the anchor DPF 210, the paging controller 320 transmits a paging message PAG to the terminal 100 so that it can perform the paging process of the RAT2 network (S350). The paging message PAG includes information (Delegation) that the corresponding message is for paging delegation of a different type of network, a value RAT_Type representing the type of the corresponding network (i.e., RAT1 network), and the terminal's wireless access interface identifier (for example, an IP address). As described above, the paging process may be performed through a different network even by the paging delegation registration information when the paging process cannot be performed through a predetermined network.

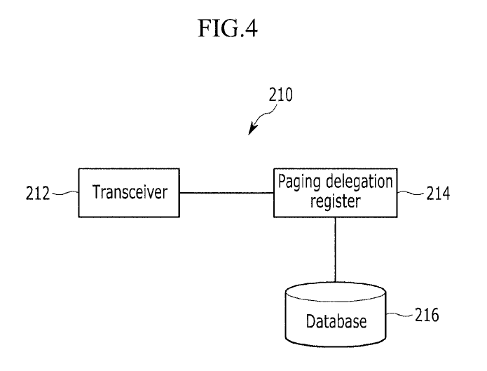

Hereinafter, an anchor DPF 210 according to an embodiment of the present invention will be described with reference to FIG. 4. As described above, the anchor DPF 210 acts as a paging delegation apparatus for setting the paging delegation registration information.

FIG. 4 is a schematic block diagram showing an anchor DPF according to an embodiment of the present invention.

Referring to FIG. 4, the anchor DPF 210 includes a transceiver 212, a paging delegation register 214, and a database 216.

The transceiver 212 transmits and receives a paging delegation request message PAG_DLG_REQ and a response message PAG_DLG_RSP thereto, and transmits a paging request message PAG_REQ and then receives a response message PAG_RSP thereto. The paging delegation register 214 set paging delegation registration information such as Table 1 on the database 216, based on the response message PAG_DLG_RSP from the paging controller 320.

As describe above, according to embodiments of the present invention, by setting a different network as a paging delegation network of a specific network in heterogeneous networks, paging delegation may occur through the different network when the paging process cannot be executed because of powering off of the corresponding interface to the specific network, deregistration, or narrow coverage of the specific network.

Embodiments of the present invention are not embodied only by a method and apparatus. Alternatively, the embodiments may be embodied by a program performing functions that correspond to the configuration of the embodiments, or a recording medium on which the program is recorded.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for paging delegation in a gateway of a first network among heterogeneous networks, the method comprising:
receiving from a terminal a first request message that requests a second network to perform paging delegation of the first network;
transmitting to a paging controller of the second network a second request message that requests paging delegation of the first network;
receiving a first response message including a result value for the paging delegation request from the paging controller;
setting paging delegation registration information of the terminal based on the first response message; and
transmitting a second response message to the terminal.

2. The method of claim 1, wherein the paging delegation registration information comprises information on the paging controller and a status value of an interface for the first network of the terminal when the result value of the first response message represents success of the paging delegation request.

3. The method of claim 2, wherein the status value represents that the interface for the first network is reachable via the second network.

4. The method of claim 2, wherein the information on the paging controller comprises at least one of an identifier of the paging controller, an internet protocol (IP) address, and a medium access control (MAC) address.

5. The method of claim 1, wherein the second response message comprises the result value and a status value of the interface for the first network.

6. The method of claim 1, wherein the first request message comprises type information of the first network, an identifier of the terminal, and an identifier of the paging controller.

7. The method of claim 1, wherein the second request message comprises type information of the first network and an identifier of the terminal.

8. A method for paging delegation in a gateway of a first network among heterogeneous networks, the method comprising:
receiving traffic toward a terminal;
confirming the status of an interface for the first network of the terminal is reachable via a second network and identifying the information about the paging controller of the second network, based on paging delegation registration information of the terminal;
transmitting a paging request message to the paging controller; and
receiving a response message to the paging request message from the paging controller.

9. The method of claim 8, wherein the paging controller performs paging to the terminal when a result value of the response message represents success of the paging request.

10. The method of claim 8, wherein the paging request message comprises an identifier of the terminal and type information of the first network.

11. The method of claim 8, wherein the information on the paging controller comprises at least one of an identifier of the paging controller, an internet protocol (IP) address, and a medium access control (MAC) address.

12. An apparatus for paging delegation, the apparatus comprising:
a transceiver configured to receive from a terminal a first request message that request paging delegation of a first network, to transmit to a paging controller of a second network a second request message that requests paging delegation, to receive a first response message including a result value of paging delegation request from the paging controller, and to transmit a second response message to the terminal;
a database; and
a paging delegation register configured to set paging delegation registration information of the terminal on the database.

13. The apparatus of claim 12, wherein the transceiver is further configured to transmit a paging request message to the paging controller based on the paging delegation registration information when traffic toward the terminal occurs, and receives a third response message to the paging request message from the paging controller.

14. The apparatus of claim 13, wherein the paging controller is further configured to perform paging to the terminal when a result value of the third response message represents success.

15. The apparatus of claim 13, wherein the paging delegation information comprises information on the paging controller and a status value of the interface for the first network of the terminal when a result value of the first response message represents success of the paging delegation request.

16. The apparatus of claim 15, wherein the status value represents that the interface for the first network is reachable via the second network.
